(19) United States
(12) Patent Application Publication
(10) Pub. No.: US 2024/0383386 A1
(43) Pub. Date: Nov. 21, 2024

(54) FOAM, COMPONENT COMPRISING FOAM, AND METHOD

(71) Applicant: Lear Corporation, Southfield, MI (US)

(72) Inventors: Salma Sennani, Tangier (MA); Martin Deissard, Vélizy (FR); Asad S. Ali, Troy, MI (US); Reza Fard-Aghaie, Sunderland (GB); Ian Dixon, Washington (GB); Ray A. Romero, Madison, MS (US)

(73) Assignee: Lear Corporation, Southfield, MI (US)

(21) Appl. No.: 18/663,152

(22) Filed: May 14, 2024

Related U.S. Application Data
(60) Provisional application No. 63/502,273, filed on May 15, 2023.

(51) Int. Cl. B60N 2/64; B29C 45/00; B29C 45/14; B29C 45/34; B29K 21/00; B29K 75/00; B29K 105/00; B29K 105/04; B29K 105/16; B29K 105/24; B29L 31/00; B29L 31/30

(52) U.S. Cl. CPC B60N 2/643; B29C 45/0001; B29C 45/14065; B29C 45/34; B29K 2021/00; B29K 2075/00; B29K 2105/0014; B29K 2105/04; B29K 2105/16; B29K 2105/24; B29K 2995/0063; B29K 2995/0077; B29K 2995/0081; B29L 2031/3005; B29L 2031/771

(57) ABSTRACT

A method comprises disposing a trim piece on a first mold portion, clamping the trim piece to the first mold portion via a clamp, closing a second mold portion, injecting foam resin into a mold cavity and onto the trim piece, the mold cavity defined at least in part by the first mold portion and the second mold portion, and curing the foam resin to form a component. The component can comprise a back panel for a seatback of a vehicle seat.

### CROSS-REFERENCE TO RELATED APPLICATIONS

This application claims the benefit of and priority to U.S. Provisional Application 63/502,273 filed May 15, 2023, the disclosure of which is hereby incorporated by reference in its entirety as though fully set forth herein.

### TECHNICAL FIELD

The present disclosure generally relates to foam, components including foam, and methods of forming components including foam, such as vehicle seat components, for example.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a seat assembly according to teachings of the present disclosure.

FIGS. 2-4 are perspective views generally illustrating portions of embodiments of seatbacks of seat assemblies according to teachings of the present disclosure.

FIG. 5 is a front view generally illustrating an embodiment of a seatback panel according to teachings of the present disclosure.

FIG. 6 is a rear view generally illustrating an embodiment of a seatback panel according to teachings of the present disclosure.

FIGS. 7-9 are perspective views generally illustrating portions of an embodiment of a machine for forming components comprising foam according to teachings of the present disclosure.

FIG. 10 is a side view generally illustrating portions of an embodiment of a machine for forming components comprising foam in an open position according to teachings of the present disclosure.

FIG. 11 is a top view generally illustrating a first mold portion of an embodiment of a machine according to teachings of the present disclosure.

FIG. 12 is a bottom view generally illustrating a second mold portion of an embodiment of a machine according to teachings of the present disclosure.

FIG. 13 is a perspective view generally illustrating a second mold portion of an embodiment of a machine according to teachings of the present disclosure.

FIG. 14 is a perspective view generally illustrating portions of an embodiment of a machine for forming components comprising foam in an open position according to teachings of the present disclosure.

FIG. 15 is a perspective view generally illustrating portions of an embodiment of a machine for forming components comprising foam in an open position and a trim piece disposed on a first mold portion according to teachings of the present disclosure.

FIGS. 16 and 17 are perspective views generally illustrating an embodiment of a clamp according to teachings of the present disclosure.

FIGS. 18 and 19 are perspective views generally illustrating portions of an embodiment of a machine for forming components comprising foam with a second mold portion in an open position and a trim piece clamped on a first mold portion according to teachings of the present disclosure.

FIG. 20 is a side view generally illustrating portions of an embodiment of a machine for forming components comprising foam in a closed position according to teachings of the present disclosure.

FIG. 21 is an enlarged portion of portion XXI of FIG. 20.

FIG. 22 is a perspective view generally illustrating portions of an embodiment of a machine for forming components comprising foam in a closed position according to teachings of the present disclosure.

FIG. 23 is a perspective generally illustrating portions of an embodiment of a machine for forming components comprising foam in an open position and a formed component disposed on a first mold portion according to teachings of the present disclosure.

FIG. 24 is a perspective generally illustrating portions of an embodiment of a machine for forming components comprising foam in a closed position and a formed component partially removed from a first mold portion according to teachings of the present disclosure.

FIG. 25 is a perspective view generally illustrating an embodiment of a component comprising foam according to teachings of the present disclosure.

FIG. 26 is a flow diagram generally illustrating an embodiment of a method of forming a component comprising foam according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

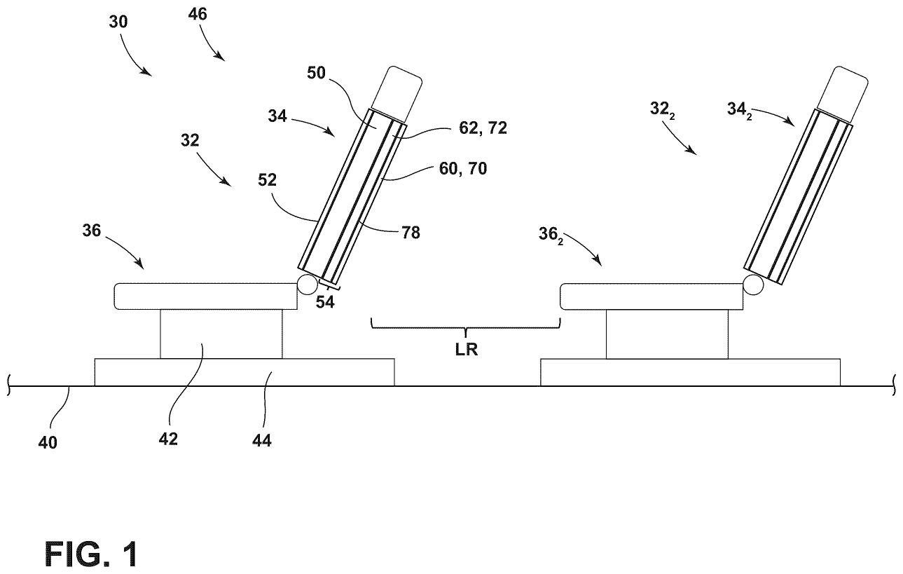

Referring to FIG. 1, a seat assembly 30 is illustrated with a first seat 32 and a second seat 322. The seats 32, 322 each include a seatback 34, 342 and a seat bottom 36, 362. The seat bottom 36 is configured for connection with a mounting surface 40, such as via a seat base 42 and/or a track assembly 44. Optionally, the mounting surface 40 is disposed in a vehicle 46, and/or includes a floor of the vehicle 46.

The seatback 34 includes a seatback frame 50, a trim cover 52, and a back panel 54. The back panel 54 includes a first portion 60 and a second portion 62. In vehicle applications, the back panel 54 can be a vehicle seat back panel. The first portion 60 includes a trim piece 70 and the second portion 62 includes a foam 72 (e.g., a polyurethane foam, an MDI microcellular urethane foam, among others), in the illustrated example. The trim piece 70 functions as the outer surface of the back panel 54. The foam 72 is disposed at an inner surface 78 (e.g., a back side) of the trim piece 70. A distance between the back panel 54 of the first seat 32 and the front of the seat bottom 36 of the second seat 322, which may be disposed behind the first seat 32, may define, at least in part, legroom LR for the occupant of the second seat 322. The trim piece 70 may, for example and without limitation, include vinyl, among other materials, and may include combinations of materials.

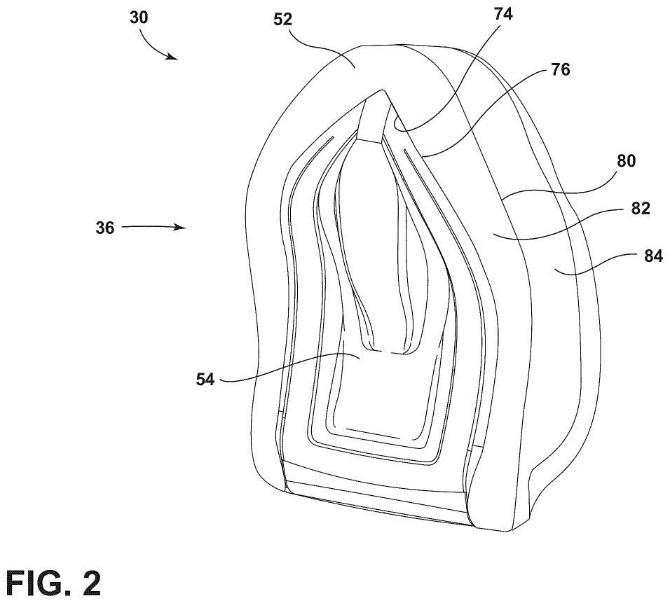

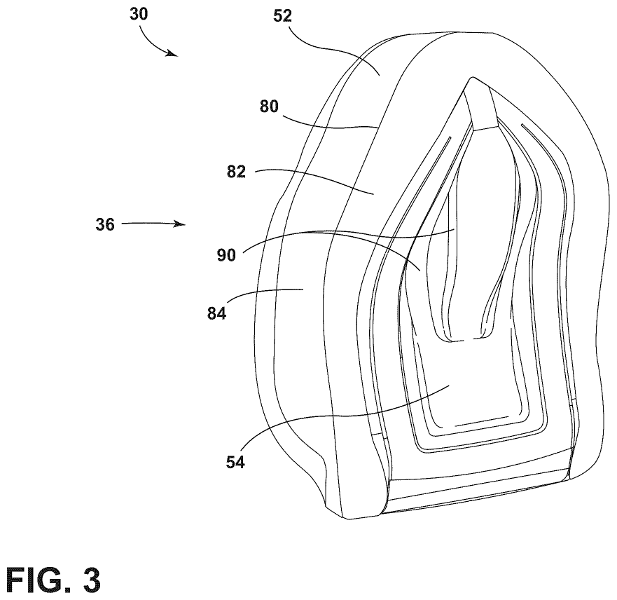

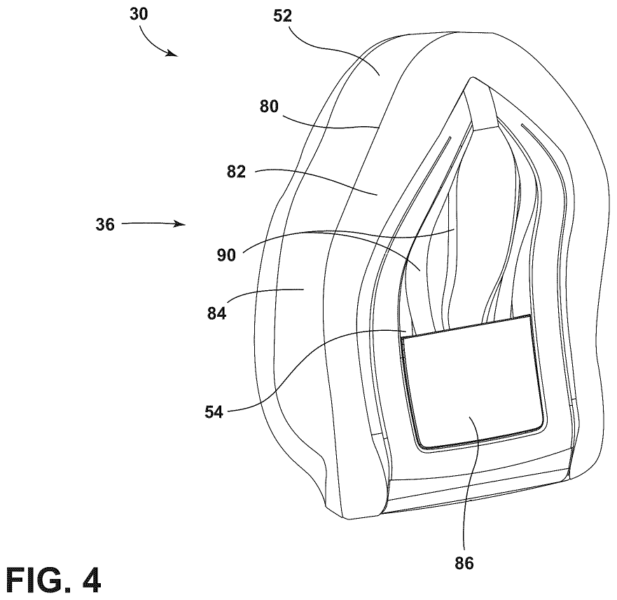

Referring to FIGS. 2-4, examples of seatbacks 34, including a trim cover 52 and a back panel 54, are illustrated. One or more edges 74 of the back panel 54 (e.g., the trim piece 70) are connected (e.g., via sewing, high frequency bonding, other methods) to the edges 76 of the trim cover 52. Optionally, the trim cover 52 includes a zipper 80 to facilitate assembly of the combined trim cover 52 and back panel 54 with the seatback frame 50. The zipper 80 separates the trim cover 52 into a first section 82 and a second section 84. The back panel 54 can be sewn with the first section 82. The first section 82 can be coupled with the second section 84 via the zipper 80, such as during assembly with the seatback frame 50 (FIG. 1). In some configurations, such as illustrated in FIG. 4, the back panel 54 includes a pocket 86, which may be referred to as a map pocket.

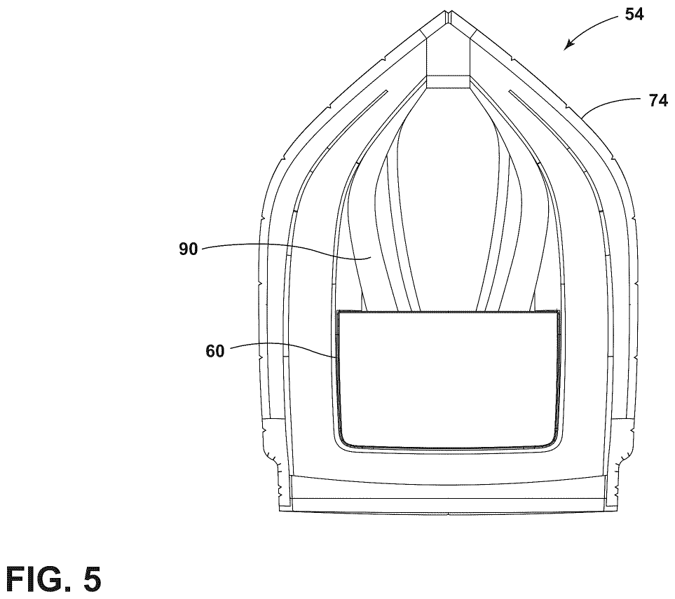

Referring to FIG. 5, a front view of the back panel 54 is illustrated prior to connection with the trim cover 52 (FIG. 2). In the front view, the first portion 60 is visible and the second portion 62 (FIG. 1) is hidden. The front of the back panel 54, when assembled with the seat 32 is disposed at the at the rear of the seat 32 such that the first portion faces rearward (e.g., toward the front of the second seat 322 in the configuration shown in FIG. 1). Optionally, the back panel 54 includes one or more formations 90, such ridges and/or protrusions, that improve the appearance of the back panel 54.

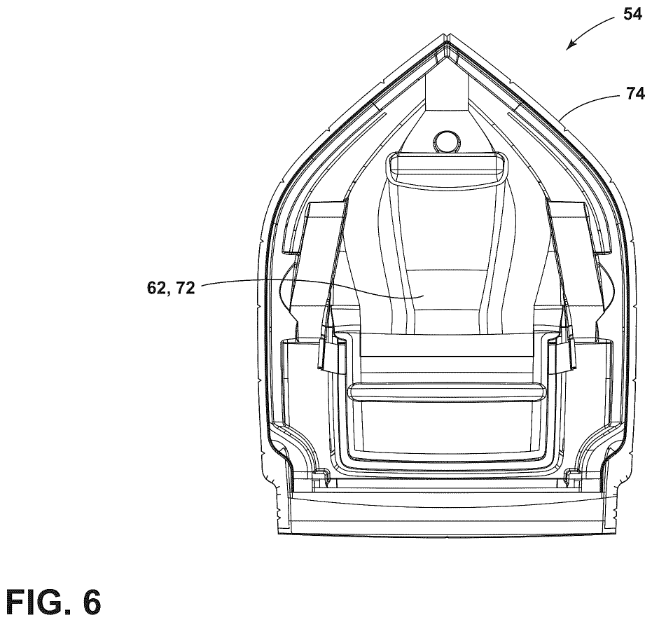

Referring to FIG. 6, a rear view of the back panel 54, including the second portion 62 and the foam 72 thereof. When assembled with the seat 32, the second portion 62 and the foam 72 are inward of and covered by the first portion 60 (FIG. 5).

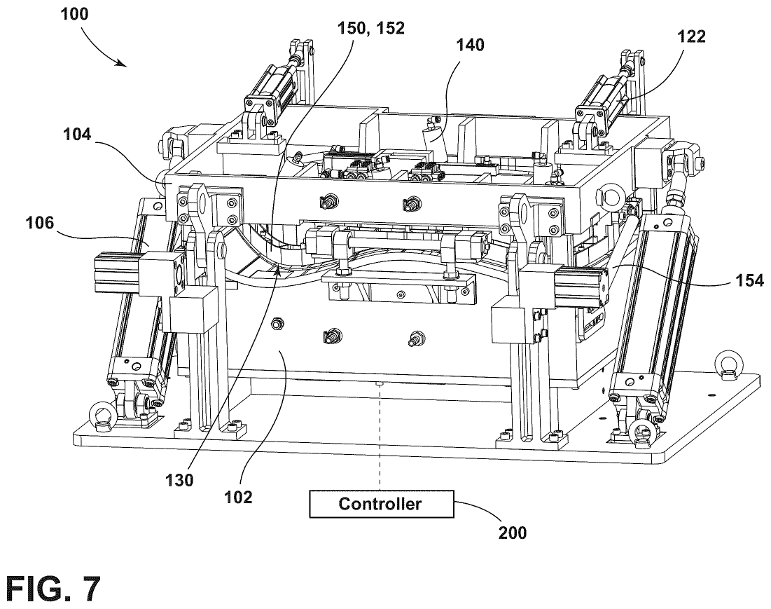

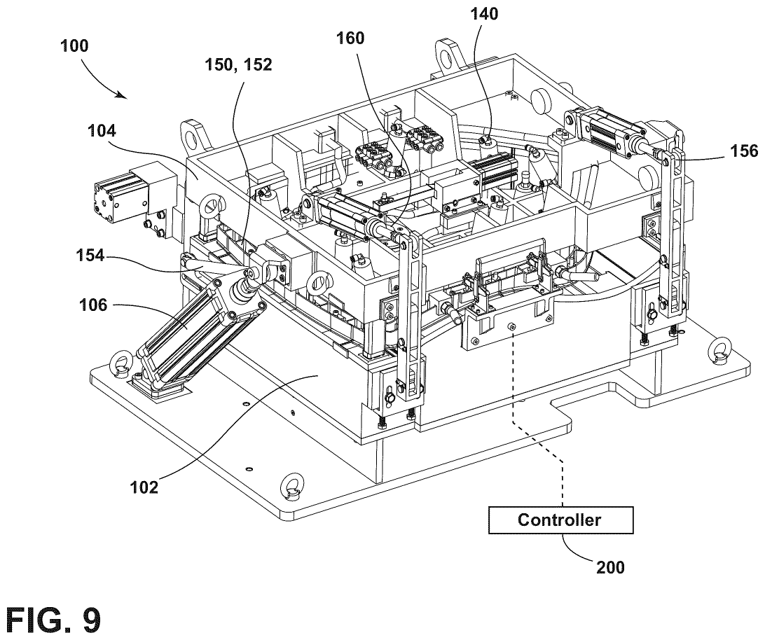

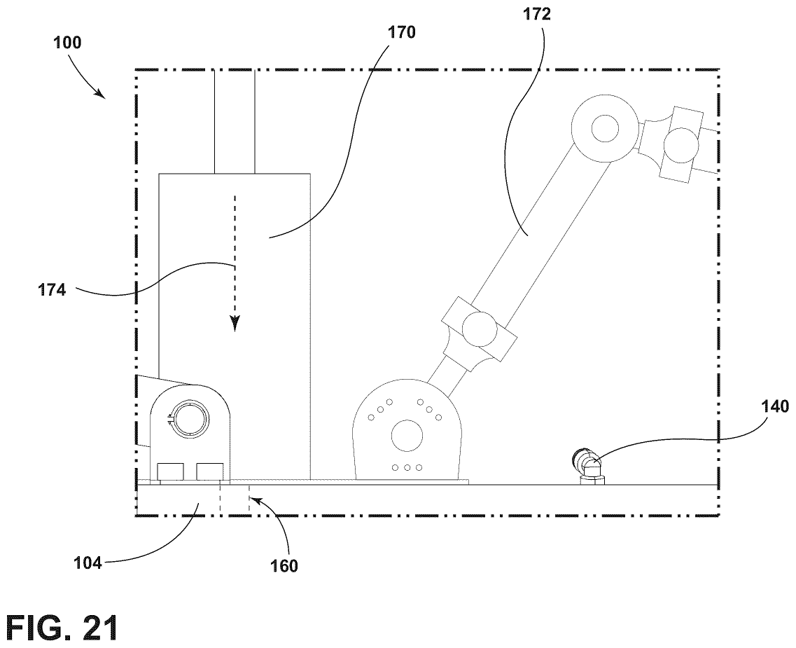

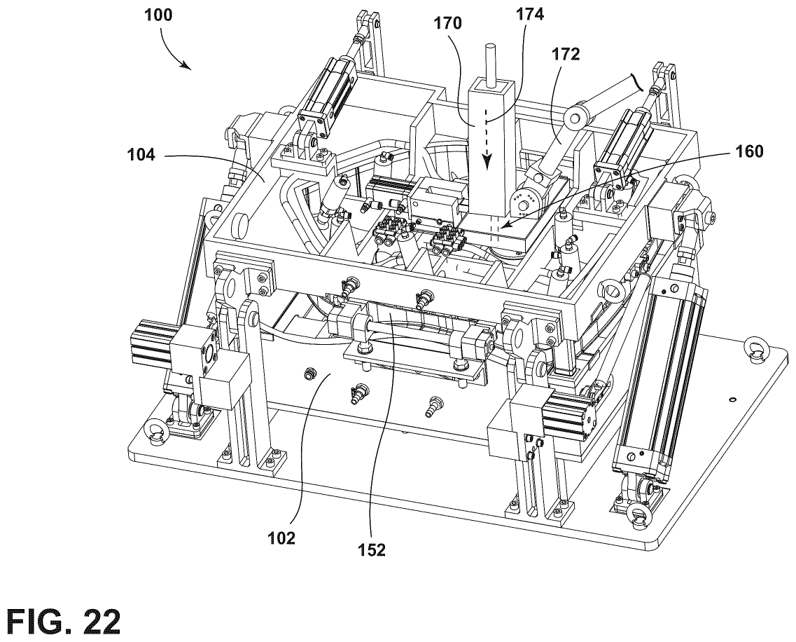

Referring to FIGS. 7-24, various portions of a method and a machine 100 for forming components, such as the back panel 54, are illustrated.

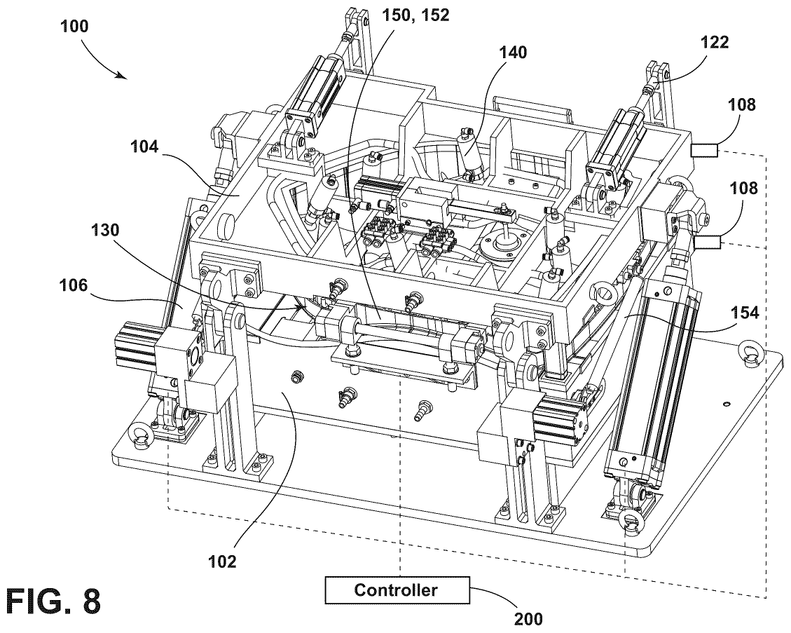

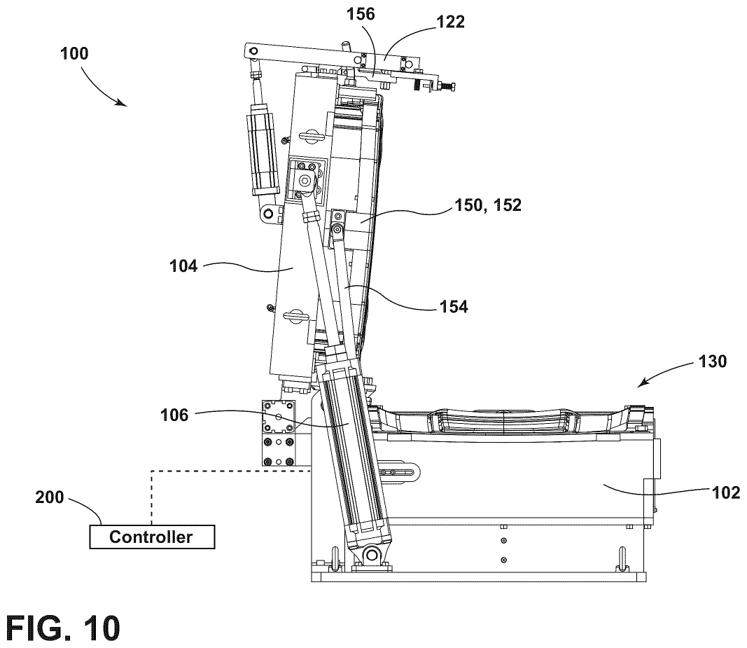

Referring to FIGS. 7-10, first front perspective, second front perspective, rear perspective, and side views illustrate the machine 100 that can be used for forming the back panel 54 is illustrated. The machine 100 includes a first mold portion 102 and a second mold portion 104 that cooperate to at least partially define a mold cavity 130 for forming components, such as the back panel 54. At least one of the first mold portion 102 and the second mold portion 104 can move relative to the other. For example, one or more actuators 106 (e.g., pivoting cylinders) may movably couple the second mold portion 104 to the first mold portion 102. In the illustrated example, the second mold portion 104 is movable to and between a closed position (see, e.g., FIGS. 7-9) and an open position (see, e.g., FIG. 10) relative to the first mold portion 102. The one or more actuators 106 move the second mold portion 104 between the open and closed positions. Referring to FIG. 8, the machine 100 can include one or more heaters 108 that can heat the first mold portion 102 and/or the second mold portion 104, such as to facilitate molding of the trim piece 70 and/or formation of the foam 72 on the trim piece 70.

Referring to FIG. 10, the second mold portion 104 can include one or more latches/locks 122. In some configurations, the actuators 106 move the second mold portion 104 onto a first mold portion 102 and/or a clamp 150, and/or the one or more latches/locks 122 clamp the second mold portion 104 to the first mold portion 102 with the trim piece 70 and the clamp 150 therebetween.

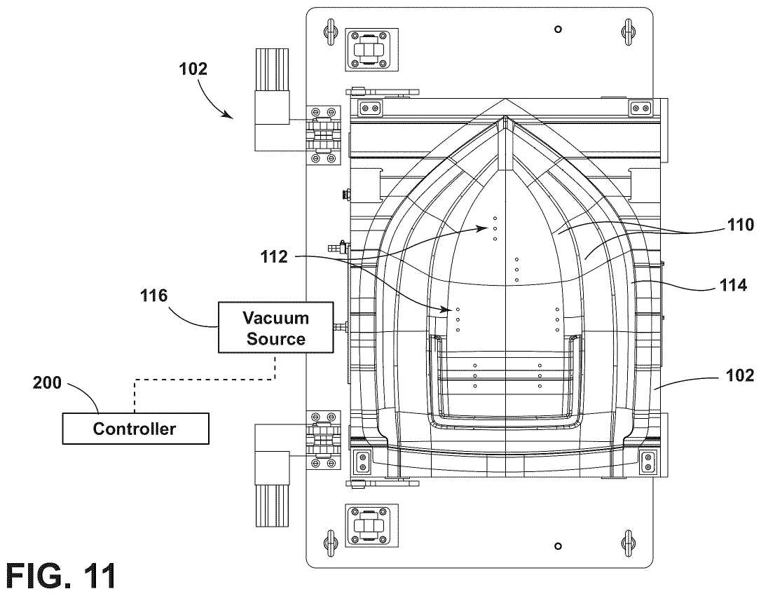

A top view of the first mold portion 102 is illustrated in FIG. 11. The first mold portion 102 includes formations 110 (e.g., protrusions, recesses, angled portions, among others) that correspond to the formations 90 of the back panel 54. Additionally or alternatively, the first mold portion 102 includes a plurality of vacuum holes 112. The machine 100 can, at least temporarily, hold a trim piece 70 in place relative to the first mold portion 102 via the plurality of vacuum holes 112. The machine 100, additionally or alternatively, can apply a vacuum to the plurality of vacuum holes 112 to apply a vacuum pressure to the trim piece 70 to cause the trim piece 70 to deform into the shape of the first mold portion 102, which may include deforming to match the formations 110. A few vacuum holes 112 are shown in a few locations for illustration, but the first mold portion 102 can include any appropriate number of vacuum holes 112 disposed in appropriate locations. In some configurations, the plurality of vacuum holes 112 are disposed inward of a trim outline/perimeter 114 of the first mold portion 102 and/or proximate the formations 110. A vacuum source 116 (e.g., a fan, a pump, among others) is fluidly coupled to the vacuum holes 112.

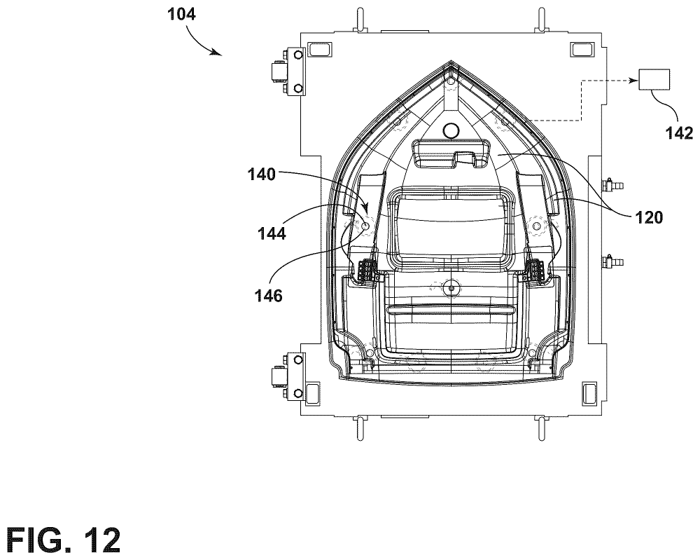

A bottom view of the second mold portion 104 is generally illustrated in FIG. 12. The second mold portion 104 includes second mold formations 120 that correspond the formations 110 of the first mold portion 102 and/or the formations 90 of a formed back panel 54. The second mold portion 104 cooperates with the first mold portion 102 to define, at least in part, the mold cavity 130 into which foam 72 is injected. Optionally, the second mold portion 104 includes one or more vents 140 fluidly coupled with the mold cavity 130 and an external space/environment 142 such that the vents 140 can vent fluid from the mold cavity 130 to the external space 142. For example, when material (e.g., foam 72) is injected into the mold cavity 130, the vents 140 can vent existing fluid (e.g., air) from the mold cavity 130. In some instances, the foam 72 may produce an exhaust fluid, such as during curing, and the vents 140 can vent the exhaust fluid to the external space 142. The external space 142 may, with some examples, include one or more filters. The vents 140 may facilitate limiting the formation of air pockets of voids in the formed foam 72. The vents 140 can, for example, include fluid conduits, fluid passages, other configurations, or combinations thereof.

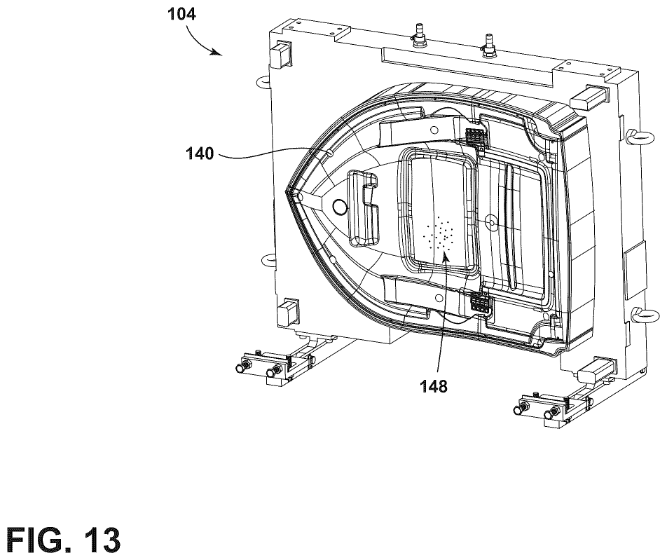

Optionally, the vents 140 include pins 144. The pins 144 are disposed at least partially in the vents 140 and can move between a retracted position and an extended position. During formation of a component, such as the back panel 54, the pins 144 are disposed in the retracted position. Once formation is complete, the pins 144 can be moved to the extended position, such as via compressed air provided to the pins 144. In the extended position, the pins 144 may be cleaned, manually and/or automatically (e.g., via a robot), such as to remove foam resin and/or other material that may build up in the vent 140. In some configurations, the pins 144 have a different cross-sectional shape than the vents 140. For example, the vents 140 may be circular and/or the pins 144 may be polygonal (e.g., hexagonal) such that fluid (e.g., gas exiting the mold cavity 130) can flow between at least some portions of the pins 144 and the surface/walls 146 of the vents 140 when the pins 144 are in the extended position and/or the retracted position. Referring to FIG. 13, the second mold portion 104 may be inspected, tested, cleaned, heated, and/or coated with a release agent 148 (e.g., wax) between cycles.

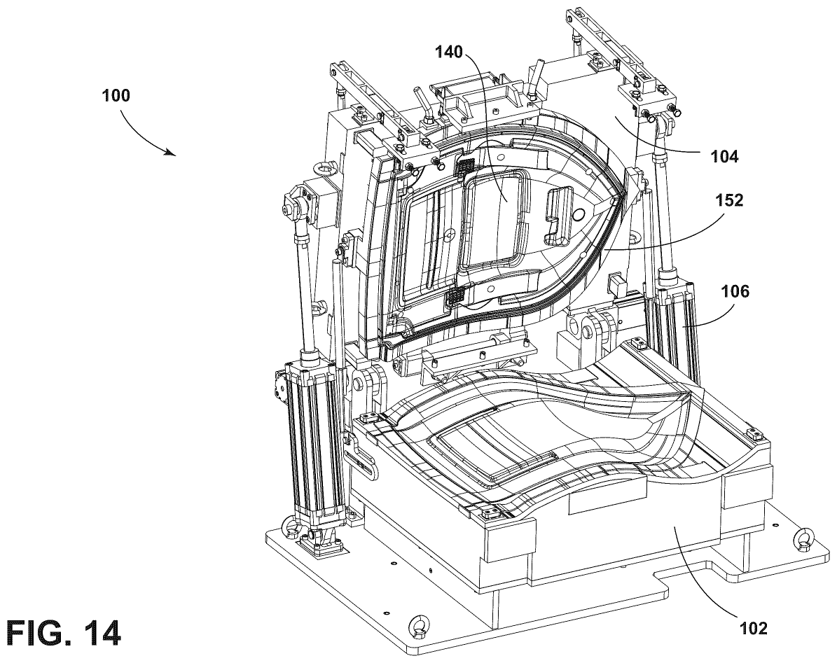

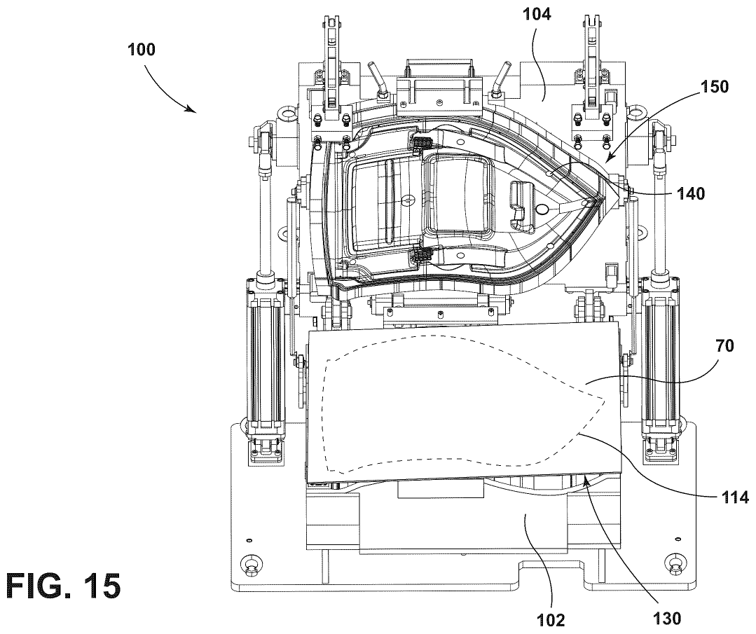

Referring to FIG. 14, the machine 100 is in an open position. In FIG. 15, the machine 100 is shown in the open position with a trim piece 70 disposed on the first mold portion 102 prior to activation of the machine 100 and with the clamp 150 in contact with or adjacent the second mold portion 104. At least some of the trim piece 70 (e.g., a portion on which foam 72 will be formed) is disposed in the mold cavity 130.

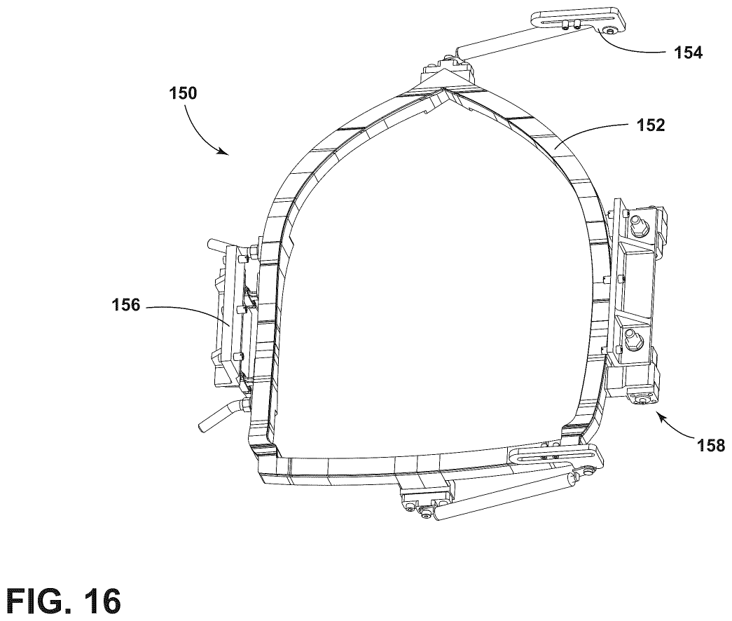

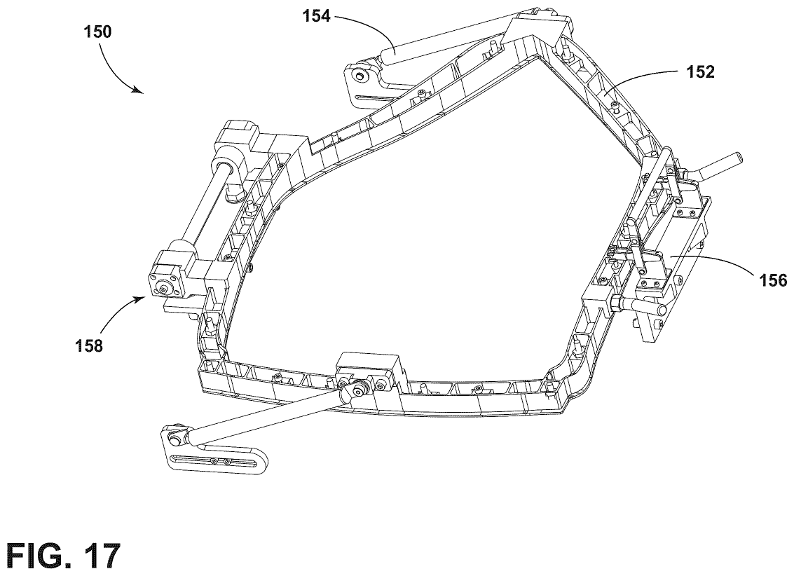

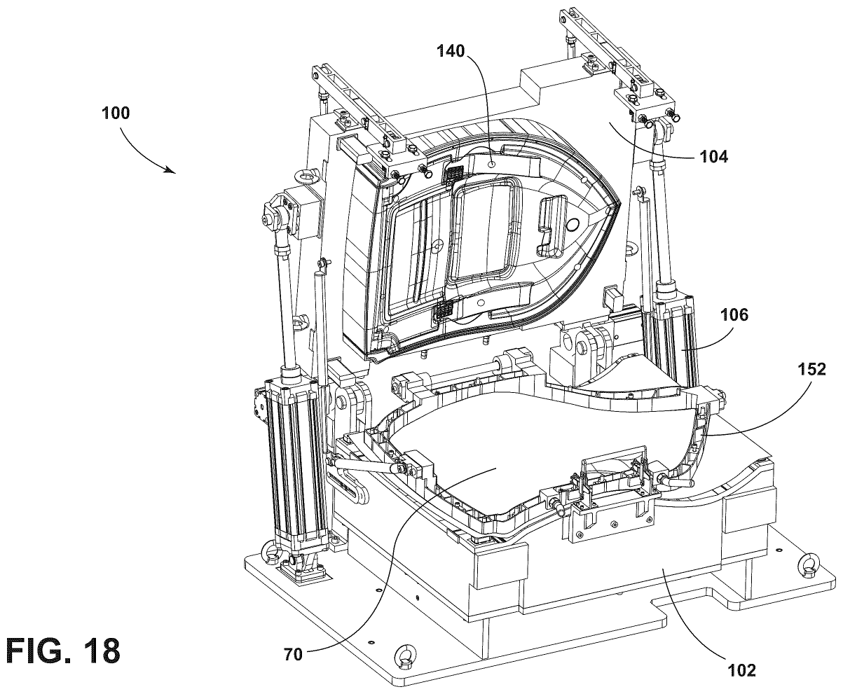

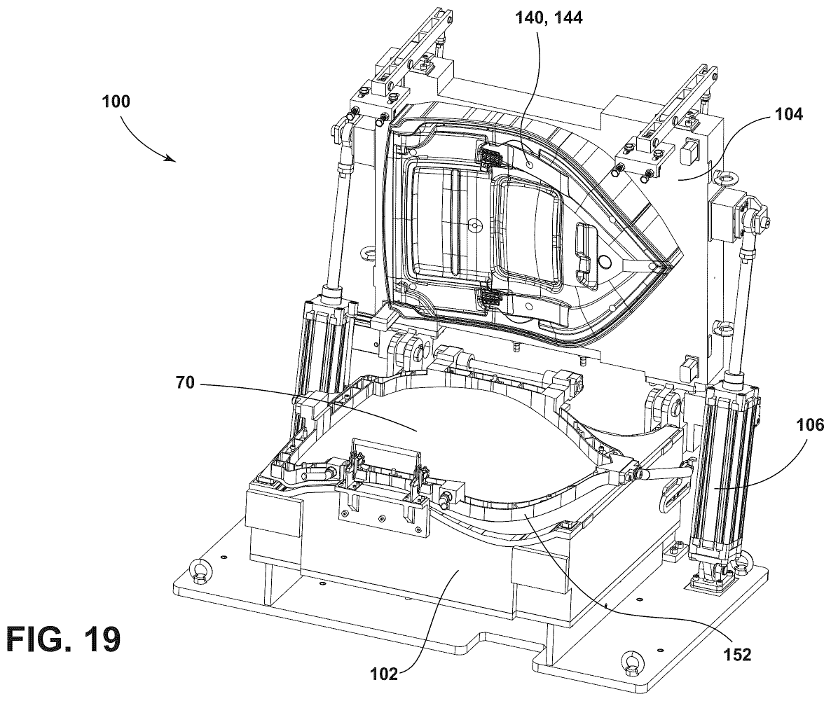

Referring to FIGS. 16 and 17, the clamp 150 of the machine 100 is illustrated. The clamp 150 is configured to clamp the trim piece 70 with the first mold portion 102, such as at or about a trim outline/perimeter 114 (FIG. 15) of the trim piece 70. When clamped, the clamp 150 restricts and/or prevents movement of at least portions of the trim piece 70 (e.g., portions proximate the trim outline/perimeter 114) relative to the first mold portion 102. The illustrated clamp 150 includes a frame 152 and one or more actuators 154 (e.g., linear actuators, cylinders, motors, among others), one or more latches/locks 156, and a hinge 158. In some configurations, the actuators 154 move the frame 152 about the hinge 158 from the open/unclamped position shown in FIG. 14 to the position shown in FIGS. 18 and 19 with the frame 152 on the trim piece 70. The one or more latches/locks 156 then clamp the frame 152 to the first mold portion 102 with the trim piece 70 therebetween. In some configurations, the clamp 150 (e.g., the frame 152) cooperates with the first and second mold portions 102, 104 to define the mold cavity 130. For example, the frame 152 can be form a fluid seal with the first mold portion 102 and/or the second mold portion 104. After the trim piece 70 is clamped, vacuum can be applied to the trim piece 70 to pull the trim piece 70 into contact with the formations 110 (FIG. 11) of the first mold portion 102.

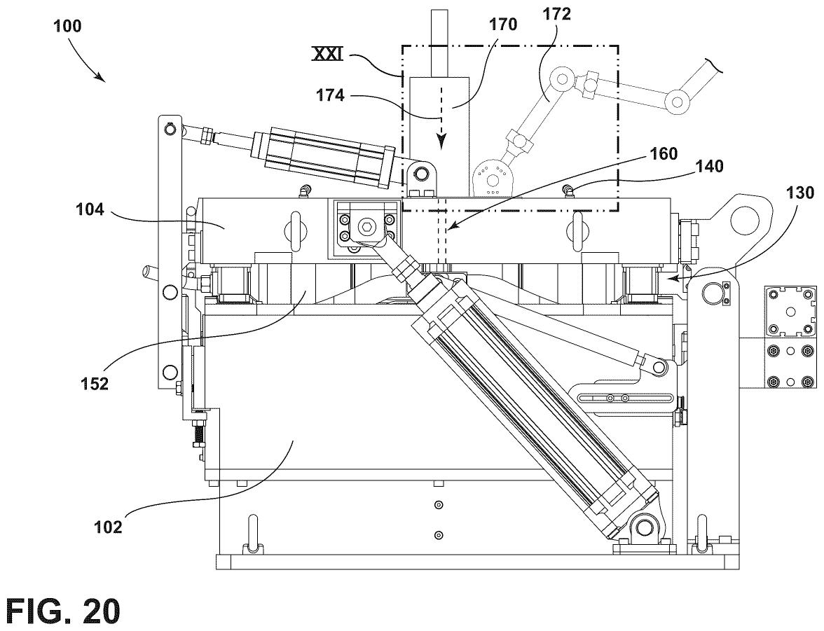

Referring to FIGS. 20-22, after the trim piece 70 is disposed on the first mold portion 102, clamped via the clamp 150, and/or vacuumed to the first mold portion 102, the second mold portion 104 is closed, such as via one or more actuators 106. Once the second mold portion 104 is closed, the mold cavity 130 may be closed, such as except for one or more foam injection ports 160 (e.g., the foam resin 174 may be injected as a closed pour) and/or one or more vents 140. A foam injector 170 is at least selectively fluidly coupled with the machine 100, such as to the one or more foam injection ports 160. In some configurations, the foam injector 170 is coupled to and moves with an arm 172 (e.g., a robotic arm) that moves at least a portion of the foam injector 170 into or proximate a fluid coupling position with the one or more foam injection ports 160. In some configurations, the foam injector 170 is permanently coupled with the machine 100. The foam injector 170 injects foam resin 174 into the mold cavity 130, such as via the one or more foam injection ports 160. In some configurations, the foam injector 170 is permanently coupled with the machine 100 (e.g., the arm 172 can be omitted). While the foam resin 174 is injected and/or while the foam resin 174 cures in the mold cavity 130, the one or more vents 140 can vent fluid, such as air and/or exhaust gas, from the mold cavity 130.

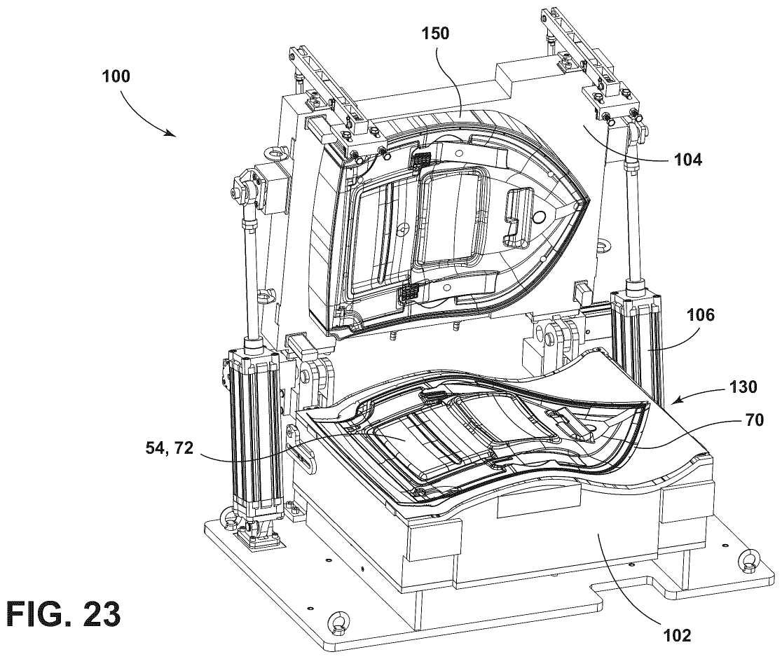

Referring to FIG. 23, the machine 100 is shown in the open position after injection of the foam resin 174 into the mold cavity 130 and curing of the foam resin 174 on the trim piece 70. When injection and curing are complete, the second mold portion 104 is rotated to the open position, the clamp 150 is unclamped from first mold portion 102 and the trim piece 70, and the clamp 150 rotated to the open position. The back panel 54 is shown disposed on the first mold portion 102 of after the foam resin 174 is injected into the mold cavity 130 and cured on the trim piece 70.

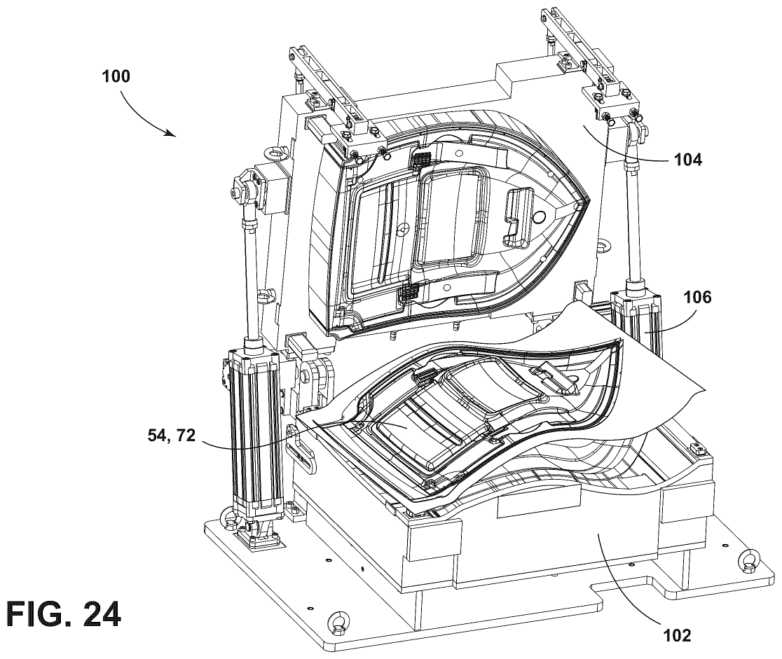

Referring to FIG. 24, the back panel 54 is shown partially removed from a machine 100 after foam resin 174 is injected into the mold cavity 130 and cured.

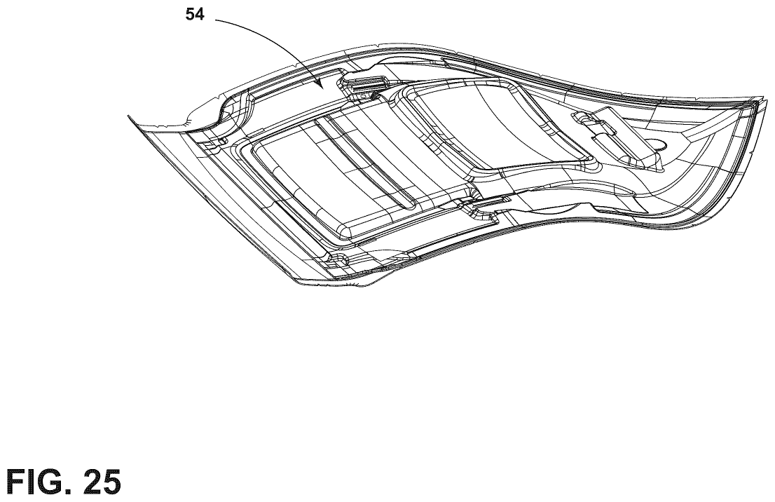

Referring to FIG. 25, the formed back panel 54 is shown after completely removing the back panel 54 from the machine 100. In some configurations, extra portions of the trim piece 70 and/or the foam 72 can be trimmed (e.g., cut) from the back panel 54.

A controller 200 is operably coupled to and/or controls, at least in part, operation of the machine 100. For example and without limitation, the controller 200 is operably coupled to and/or controls, at least in part, the one or more actuators 106, one or more heaters 108, the vacuum source 116, the clamp 150, such as the one or more actuators 154 and/or the latches/locks 156, the foam injector 170, and/or the arm 172.

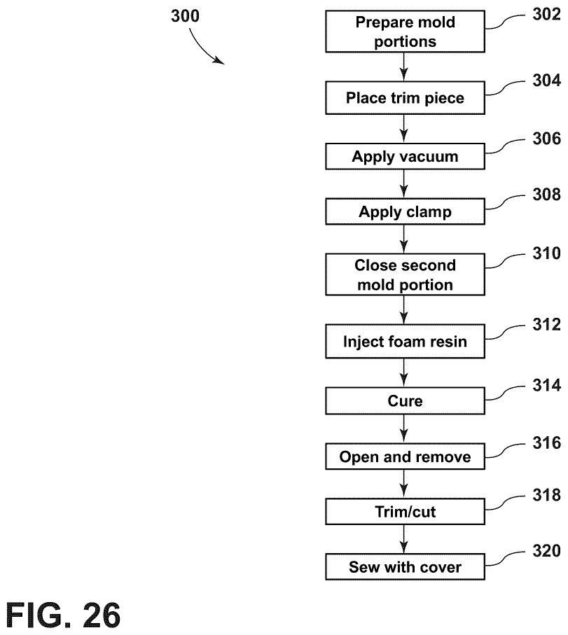

Referring to FIG. 26, a method 300 of forming a component including foam 72, such as the back panel 54, is illustrated. The method 300 includes preparing one or more mold portions 102, 104 of a machine 100 (block 302), which may include heating (e.g., via heater(s) 108), coating with a release agent, and/or cleaning the first mold portion 102, the second mold portion 104 (e.g., pins 144), and/or portions thereof (e.g., the vent pins 144). In some configurations, block 302 is conducted for each component formed and, in other configurations, block 302 can be conducted after a certain number of components are formed or can be omitted. The method 300 includes placing the trim piece 70 on the first mold portion 102 (block 304), applying vacuum to the trim piece 70 via one or more vacuum holes 112 (block 306), and/or clamping the trim piece 70 with the first mold portion 102 via a clamp 150 (block 308). In some configurations, block 308 occurs prior to and/or at the same time as block 306. The method 300 includes closing the second mold portion 104, which may close a mold cavity 130 (block 310), such as other than one or more foam injection ports 160 and/or vents 140. The method 300 includes injecting foam resin 174 into the mold cavity (block 312) and allowing the foam resin 174 to cure (block 314). Curing may, in some examples, involve four minutes or less, such as about 2-3 minutes. Injection and/or curing of the foam resin 174 can result in a foam 72 being formed on and/or adhered to the trim piece 70. Block 312 and/or block 314 can include venting fluid from the mold cavity 130 via one or more vents 140. The method 300 includes opening the second mold portion 104 and removing the formed component, such as a back panel 54 (block 316). Optionally, the method 300 includes trimming/cutting portions of the component (block 318). The method 300 can include sewing the component with another component (block 320). For example, if the component includes a back panel 54 of a seat assembly 30, the back panel 54 may be sewn with a trim cover 52. Additionally or alternatively, a zipper 80 and/or a map pocket 86 may be installed on the back panel 54.

In some instances, the combined trim cover 52 and back panel 54 may be disposed over a seatback frame 50 while a zipper 80 of the back panel 54 is open. The trim cover 52 may be attached to the seatback frame 50, such as via one or more fasteners. In some configurations, the back panel 54 may indirectly connected to the seatback frame 50 by the trim cover 52 and may not be directly connected to the seatback frame 50. Once the trim cover 52 is in a desired position, the zipper 80 may be closed (see, e.g., FIGS. 1-3).

Some example values for various parameters that can be utilized for the machine 100 and/or the method 300, or that can apply to the formed foam and/or the back panel 54, are provided in Table 1 below. Embodiments are not limited to the listed values.

TABLE 1
Example Injection Data

| PU Material Shot Weight | g | 350-450 ± 5% | (e.g., 400) |
|---|---|---|---|
| Material Flow Rate | g/s | 150 ± 10 | |
| Components Ratio | % | 50-70 | (e.g., 60) |
| Iso/Polyol | | | |
| Polyol stream pressure | Bar | 157.2 | |
| Iso stream pressure | Bar | 148.4 | |
| Shot time | s | 2.75 | |
| Polyol stream Temp. | ° C. | 22 ± 5 | (e.g., 26.1) |
| Iso stream Temp. | ° C. | 20° C. ± 2 | (e.g., 21.7) |
| Mold Temp. | ° C. | 45 ± 5 | (e.g., 46) |

| | | |
|---|---|---|
| Demold time | Min | 2.0-6.0 |
| Surface material/Trim Wt. | g | 250-350 |
| Trim + foam Wt. | g | 641-741 |
| Net Foam Wt. | g | 391 |
| Mold Volume | Liter | 2.9 |
| Foam density | kg/m³ | 180-280 |
| Hardness after 2 hours | Shore A | ≥50 |
| Hardness after 24 hours | Shore A | 50-60 |
| Shrinkage lengthwise | % | ≤5% |
| Shrinkage Widthwise | % | ≤5% |
| Air traps | | No |

The machine 100 can be utilized with a methylene diphenyl diisocyanate (MDI) based polyurethane (PU) for forming/molding components, such as the back panel 54 for a vehicle seat 32. With some embodiments, the formed back panel 54 can include one or more of the following properties: a Shore Hardness of 45-70, a density of 180-300 kg/m₃, a molding thickness of 2-8 mm, a demolding (cycle time) of 2-4 minutes, low emissions, and can meet flammability, odor, and staining standards.

The trim piece 70 can be molded in place with the foam 72, which may be semi-flexible and/or function as a seatback board. Such a configuration may provide more legroom LR and/or provide a softer surface for occupants of a rear seat that contact the back panel 54. For example, the back panel 54 may provide up to 30 mm of additional legroom LR for a rear occupant compared to other designs, such as designs that include hard plastics. Additionally or alternatively, embodiments of components formed according to aspects of the current disclosure may be utilized to reduce hard plastics in a vehicle 46.

Embodiments of a back panel 54 may be lighter than other back panels, such as injection molded hard plastic back panels. For example, the back panel 54 can weigh 0.5 kg, and a pair of back panels 54 (e.g., one for each seat 32, 322) can weight about 1 kg. In some examples, the back panel 54 can be coupled (e.g., sewn, high frequency bonded, etc.) with the trim cover 52, which can be directly coupled to the seatback frame 50. In other examples, the back panel 54 can be separately and directly coupled to the seatback frame 50. Some back panels 54 can include varying thicknesses, such as edges of about 3 mm and some thicker areas of up to 30 mm, for example and without limitation. Back panels 54 can be molded into various shapes and still provide a soft outer surface.

With embodiments, a foam (e.g., foam 72) may include a polyol blend, one or more adhesion promotors, one or more chain extenders and/or cross-linkers, one or more catalysts, a blowing agent, a colorant, and/or an organic isocyanate. The colorant can be utilized for aesthetic purposes.

With embodiments, the polyol blend can comprise a mixture of di-and tri-functional compounds that may have different molecular weights. Polyether polyols alone or in the mixture can have several different average molecular weights, such as from about 1,000 Daltons to 6,000 Daltons. Examples of di-and tri-functional materials include, but are not limited to, polyethylene glycol, polypropylene glycol, glycerol-based polyether triols, trimethylolpropane-based polyether triols, and the like, and mixtures thereof. In some examples, the polyether polyols may include a hydroxyl number ranging from 30.0 to 35.0 mg KOH/g, such as polyols designated as a first polyol Polyl, a second polyol Poly2, and a third polyol Poly3. In an example, one or more of the polyols has a hydroxyl number ranging from 18.2 to 22.2 mg KOH/g, such as polyols designated as a fourth polyol Poly4. The foam 72 can include a combination of the first polyol Polyl, the second polyol Poly2, the third polyol Poly3, and/or the fourth polyol Poly4.

Adhesion promotors can be included in the foam 72 to improve adhesion between the foam 72 (e.g., polyurethane foam, MDI microcellular urethane foam, among others) and various substrates, such as the trim piece 70. With some examples, adhesion promoters can include, but are not limited to, adhesion promoters produced by reacting a dicarboxylic acid with an excess of diol, for example adipic acid with ethylene glycol or butanediol, or reacting a lactone with an excess of a diol, such as caprolactone with propylene glycol. In addition, polyester polyols for use in the present disclosure may also include linear or lightly branched aliphatic (e.g., mainly adipates) polyols with a terminal hydroxyl group, low molecular weight aromatic polyesters, polycaprolactones, and/or polycarbonate polyol.

In embodiments, the foam 72 can comprise chain extenders and cross-linkers, which can include, but are not limited to, compounds having a hydroxyl or amino functional group, such as, glycols, amines, diols, or a combination thereof. The chain extender can include, for example, ethoxylated hydroquinone, diethylene glycol, 1,4-butanediol, propylene glycol, ethylene glycol, dipropylene glycol, 1,5-pentanediol, neopentyl glycol, 1,6-hexanediol, 1,10-decanediol, 1,12-dodecanediol. Additionally or alternatively, the cross-linker can include Ethanolamine, Triethanolamine, Diethanolamine Phenyldiethanolamine, Methyl diethanolamine, and/or Diethyltoluenediamine.

With some embodiments, foam can include a blowing agent, such as water, for example.

In some examples, the foam 72 can include an organic isocyanate, which can include methylene diphenyl diisocyanate (MDI). The MIDI can include variations for the preparation of polyurethane microcellular foams, such as mixtures of diphenylmethane diisocyanate and oligomers thereof having an isocyanate functionality greater than 2, which may be referred to as “crude” or polymeric MIDI (polymethylene polyphenylene polyisocyanates), and/or the variants of MDI comprising urethane, allophanate, urea, biuret, carbodiimide, uretonimine and/or isocyanurate groups. In some configurations, the isocyanate (NCO) value for the MDI is at least 30% and less than or equal to 33%.

Various example properties of one or more embodiments of the foam 72 are set forth below in Tables 2-4.

TABLE 2
Example foam formulation

| Components | Wt % |
|---|---|
| Poly1 | 35-40 |
| Poly2 | 30-35 |
| Poly3 | 1-5 |
| Poly4 | 10-20 |
| Adhesion Promoter | 1-4 |
| Crosslinker 1 | 0.2-0.4 |
| Crosslinker 2 | 0.4-0.8 |
| Chain Extender | 2-10 |
| Amine Catalyst. 1 | 0.5-2.0 |
| Amine Catalyst. 2 | 0.1-0.5 |
| Water | 1-3 |
| MDI NCO % | 30-33 |
| Isocyanate (MDI) Ratio | 40-60 |
| Colorant | 0.1-0.5 |

TABLE 3
Example hand-Mix Reactivity Profile

| | | |
|---|---|---|
| Cream time | (s) | 10-15 |
| Top of Cup | (s) | 25-30 |
| Final Rise | (s) | 35-40 |
| Tack free time | (s) | 55-65 |
| Free rise density | kg/m³ | 85-90 |

TABLE 4
Example Physical Properties

| Example Physical | | | | |
|---|---|---|---|---|
| Properties- | | | Range/ | Example |
| Molded Foam | Unit | Method | Threshold | Value |
| Density | [kg/m³] | D45 1045 | >180 | 250 |
| Hardness | Shore A | D45 1291 | ≥40 | 45-75 |
| | | ISO 7619-1 | | |
| Tensile Strength | [kPa] | D41 1050 | ≥200 | 250 |
| Elongation | [%] | D41 1050 | ≥40 | 47 |
| Tear Strength | [N/m] | D41 1048 | ≥350 | 451 |
| Flammability | mm/min | D45 | <100 | SE (self |
| Burn Rate | | 1333/FMVSS | | extinguishing) |
| | | 302 | | |
| Total VOC | μg/g | D10 5495 | <500 | 95 |
| PVC Staining | | D10 5496 | 1-5 | 5 |

The hardness and flammability examples provided in Table 4 may also apply to a component formed with the foam 72, such as the back panel 54 including the trim piece 70 onto which the foam 72 is formed and/or adhered.

The instant disclosure includes the following non-limiting embodiments:

A method, comprising: disposing a trim piece on a first mold portion; clamping the trim piece to the first mold portion via a clamp; closing a second mold portion; injecting foam resin into a mold cavity and onto the trim piece, the mold cavity defined at least in part by the first mold portion and the second mold portion; and curing the foam resin to form a component comprising foam formed on the trim piece.

The method of embodiment 1, wherein the component comprises a back panel for a seatback of a vehicle seat.

The method of any preceding embodiment, further comprising venting, via one or more vents of the second mold portion, gas from the mold cavity during the injecting and/or during the curing.

The method of any preceding embodiment, further comprising extending pins of the one or more vents.

The method of any preceding embodiment, wherein the pins having a different cross-sectional shape than the one or more vents.

The method of any preceding embodiment, wherein the pins have a polygonal cross-sectional shape and the vents have a circular cross-sectional shape.

The method of any preceding embodiment, wherein the venting includes gas moving from (e.g., exiting) the mold cavity to the one or more vents, and between walls of the one or more vents and the pins to an external space.

The method of any preceding embodiment, wherein the mold cavity is defined by the first mold portion, the second mold portion, and the clamp.

The method of any preceding embodiment, wherein clamping the trim piece includes clamping a trim outline of the trim piece via the clamp.

The method of any preceding embodiment, further comprising applying vacuum pressure to the trim piece via a plurality of vacuum holes of the first mold portion.

The method of any preceding embodiment, wherein the foam comprises: a polyol blend; an adhesion promoter; a chain extender; a cross-linker; a catalyst; a colorant, a blowing agent; and an organic isocyanate.

The method of any preceding embodiment, further comprising at least one of sewing or high frequency bonding the component with a trim cover.

The method of any preceding embodiment, further comprising installing a zipper in the component such that the component includes a first portion disposed at a first side of the zipper and a second portion disposed at a second side of the zipper.

A vehicle seat back panel formed according to the method of any preceding embodiment.

A vehicle comprising a seat including the vehicle seat back panel of any preceding embodiment sewn with a trim cover of a seatback of the seat.

The vehicle of any preceding embodiment, wherein the trim cover is directly attached to a seatback frame of the seatback; and the vehicle seat back panel is not directly attached to the seatback frame.

A foam material, comprising: a polyol blend; an adhesion promoter; a chain extender; a cross-linker; a catalyst; a blowing agent; and an organic isocyanate.

The foam material of any preceding embodiment wherein the foam material comprises the following: a density of at least 180 kg/m³; a VOC value of 100 μg/g or less; a tear strength of at least 350 N/m; and/or a tensile strength of at least 200 kPa.

The foam material of any preceding embodiment, wherein the polyol blend includes first, second, and third polyols each having a hydroxyl number of 30.0 to 35.0 mg KOH/g, and/or a fourth polyol having a hydroxyl number of 18.2 to 22.2 mg KOH/g.

The foam material of any preceding embodiment, wherein the foam material is comprised of 35-40% of the first polyol, 30-35% of the second polyol, 1-5% of the third polyol, and 10-20% of the fourth polyol.

The foam material of any preceding embodiment, wherein the blowing agent comprises water.

A back panel for a vehicle seat, the back panel comprising: a trim piece; and the foam material any preceding embodiment formed onto a back side of the trim piece.

The back panel of any preceding embodiment, wherein the back panel has a flammability of less than 100 mm/min and a hardness of 45-75 Shore A. A vehicle comprising the back panel of any preceding embodiment.

A vehicle comprising the foam material of any preceding embodiment.

A machine comprising: a first mold portion, a second mold portion, and a clamp.

The machine of any preceding embodiment, wherein at least one of the first mold portion or the second mold portion includes a vent.

The machine of any preceding embodiment, wherein the vent includes a movable pin.

The machine of any preceding embodiment, wherein the movable pin includes a different cross-sectional shape than an inner surface of the vent.

An electronic controller configured to implement the method of any preceding embodiment.

A non-transitory computer-readable storage medium having a computer program encoded thereon for implementing the method of any preceding embodiment.

In examples, a controller (e.g., the controller 200) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method, comprising:
disposing a trim piece on a first mold portion;
clamping the trim piece to the first mold portion via a clamp;
closing a second mold portion;
injecting foam resin into a mold cavity and onto the trim piece, the mold cavity defined at least in part by the first mold portion and the second mold portion; and
curing the foam resin to form a component comprising foam formed on the trim piece.

2. The method of claim 1, wherein the component comprises a back panel for a seatback of a vehicle seat.

3. The method of claim 1, further comprising venting, via one or more vents of the second mold portion, gas from the mold cavity during the injecting and/or during the curing.

4. The method of claim 3, further comprising extending pins of the one or more vents.

5. The method of claim 4, wherein the pins having a different cross-sectional shape than the one or more vents.

6. The method of claim 5, wherein the pins have a polygonal cross-sectional shape and the one or more vents have a circular cross-sectional shape.

7. The method of claim 5, wherein the venting includes the gas moving from the mold cavity to the one or more vents, and between walls of the one or more vents and the pins to an external space.

8. The method of claim 1, wherein the mold cavity is defined by the first mold portion, the second mold portion, and the clamp.

9. The method of claim 1, further comprising applying vacuum pressure to the trim piece via a plurality of vacuum holes of the first mold portion;
wherein clamping the trim piece includes clamping a trim outline of the trim piece via the clamp.

10. The method of claim 1, wherein the foam comprises:
a polyol blend;
an adhesion promoter;
a chain extender;
a cross-linker;
a catalyst;
a colorant;
a blowing agent; and
an organic isocyanate.

11. The method of claim 1, further comprising at least one of sewing or high frequency bonding the component with a trim cover.

12. A vehicle seat back panel formed according to the method of claim 1.

13. A vehicle comprising:
a seat including:
a seatback including:
a trim cover; and
the vehicle seat back panel of claim 12 sewn with the trim cover.

14. The vehicle of claim 13, wherein the trim cover is directly attached to a seatback frame of the seatback; and
the vehicle seat back panel is not directly attached to the seatback frame.

15. A foam material, comprising:
a polyol blend;
an adhesion promoter;
a chain extender;
a cross-linker;
a catalyst;
a blowing agent; and
an organic isocyanate.

16. The foam material of claim 15, wherein the foam material comprises:
i. a density of at least 180 kg/m³;
ii. a VOC value of 100 μg/g or less;
iii. a tear strength of at least 350 N/m; and
iv. a tensile strength of at least 200 kPa.

17. The foam material of claim 15, wherein the polyol blend includes first, second, and third polyols each having a hydroxyl number of 30.0 to 35.0 mg KOH/g, and a fourth polyol having a hydroxyl number of 18.2 to 22.2 mg KOH/g.

18. The foam material of claim 17, wherein the foam material is comprised of 35-40% of the first polyol, 30-35% of the second polyol, 1-5% of the third polyol, and 10-20% of the fourth polyol.

19. A back panel for a vehicle seat, the back panel comprising:
a trim piece; and
the foam material of claim 15 formed onto a back side of the trim piece.

20. The back panel of claim 19, wherein the back panel has a flammability of less than 100 mm/min and a hardness of 45-75 Shore A.
